(19) United States
(12) Patent Application Publication
(10) Pub. No.: US 2026/0302049 A1
(43) Pub. Date: Oct. 1, 2026

(54) COIL DEVICE

(71) Applicant: TDK CORPORATION, Tokyo (JP)

(72) Inventors: Tomoya ISHIHARA, Tokyo (JP); Toru TONOGAI, Tokyo (JP)

(73) Assignee: TDK CORPORATION, Tokyo (JP)

(21) Appl. No.: 19/629,632

(22) Filed: Mar. 26, 2026

(30) Foreign Application Priority Data
Mar. 27, 2025 (JP) 2025-054066

(51) Int. Cl. H01F 27/29; H01F 27/24

(52) U.S. Cl. CPC H01F 27/29; H01F 27/24

(57) ABSTRACT

A coil device includes an element body containing a magnetic material and a resin and having a mounting surface; and a conductor including a first winding portion embedded in the element body, and a first terminal portion provided at an end portion of the first winding portion and extending along the mounting surface. The first terminal portion includes an exposed portion exposed from the mounting surface. A groove is provided in the mounting surface. When viewed in a direction perpendicular to the mounting surface, the groove is provided around the exposed portion.

### BACKGROUND OF THE INVENTION

### 1. Field of the Invention

The present disclosure relates to a coil device.

Priority is claimed on Japanese Patent Application No. 2025-054066, filed on Mar. 27, 2025, the entire content of which is incorporated herein by reference.

### 2. Description of the Related Art

For example, a coil device disclosed in Patent Document 1 includes a conductor and an element body containing a magnetic material and a resin and covering the conductor. The conductor includes a winding portion embedded in the element body, and terminal portions provided at end portions of the winding portion and extending along a mounting surface. The terminal portion is partially exposed from the mounting surface, and is configured to be connectable to a land pattern of a circuit board.

### Citation List

### Patent Document

Patent Document 1: JP 2022-066107 A

### SUMMARY OF THE INVENTION

In this type of coil device, when insulation between adjacent terminal portions is low, a short-circuit failure may occur between the adjacent terminal portions, which is a risk. Therefore, there has been a demand for a coil device capable of ensuring insulation between adjacent terminal portions.

A coil device according to one embodiment of the present disclosure includes an element body containing a magnetic material and a resin and having a mounting surface; and a conductor including a winding portion embedded in the element body, and a terminal portion provided at an end portion of the winding portion and extending along the mounting surface. The terminal portion includes an exposed portion exposed from the mounting surface. A groove is provided in the mounting surface. The groove is provided around the exposed portion.

### BRIEF DESCRIPTION OF THE DRAWINGS

FIG. 1A is a perspective view illustrating one example of a coil device according to one embodiment of the present disclosure;

FIG. 1B is a perspective view of the coil device illustrated in FIG. 1A as viewed from another angle;

FIG. 2 is a cross-sectional view of the coil device illustrated in FIG. 1A, taken along line II-II;

FIG. 3 is a partially enlarged cross-sectional view of the coil device illustrated in FIG. 2;

FIG. 4 is a bottom view of the coil device illustrated in FIG. 1A;

FIG. 5A is a bottom view illustrating a modification example of the coil device illustrated in FIG. 4;

FIG. 5B is a bottom view illustrating a modification example of the coil device illustrated in FIG. 4;

FIG. 6A is a perspective view illustrating a modification example of the coil device illustrated in FIG. 1A; and

FIG. 6B is a perspective view illustrating a modification example of the coil device illustrated in FIG. 1A.

### DETAILED DESCRIPTION OF THE PREFERRED EMBODIMENTS

Hereinafter, an embodiment of the present disclosure will be described with reference to the drawings. The contents illustrated in the drawings are merely described schematically and exemplarily for understanding of the present disclosure, and the appearance, dimensional ratios, or the like may differ from the actual ones. In addition, the present disclosure is not limited to the following embodiment.

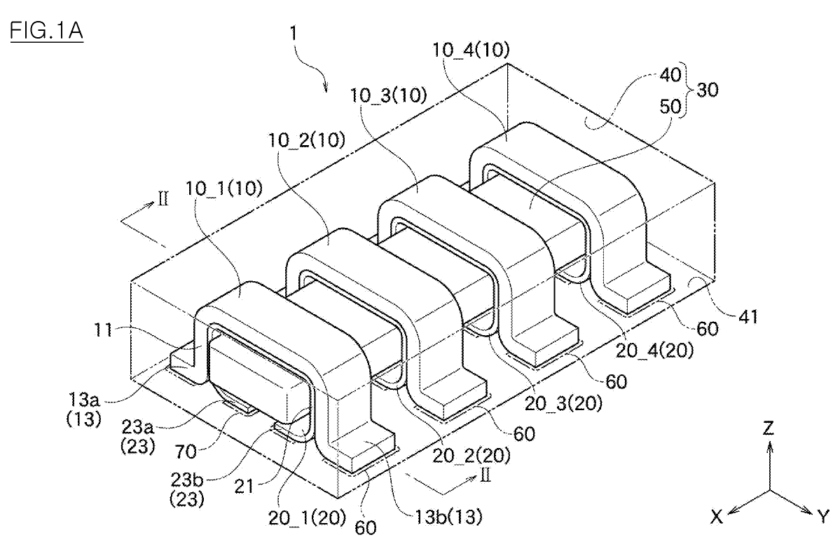

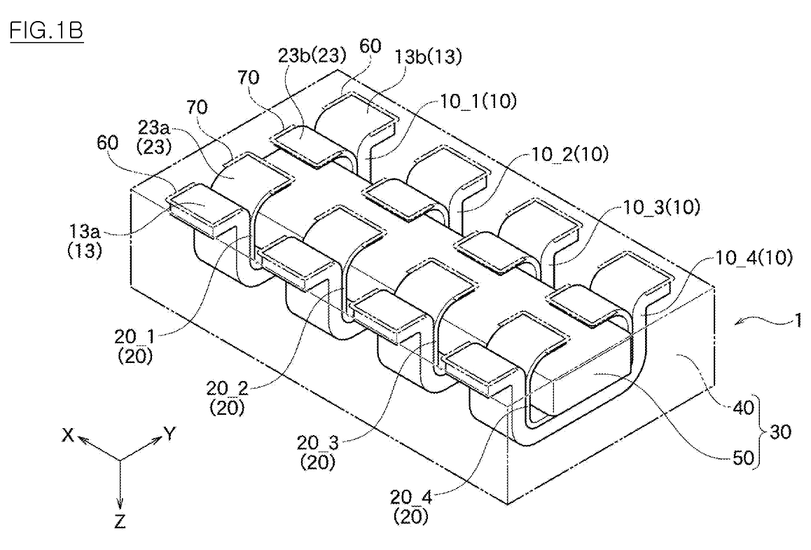

A coil device 1 according to one embodiment of the present disclosure illustrated in FIG. 1A is a magnetically coupled coil device, and is mounted on power supplies or the like of various electrical devices. The coil device 1 includes first conductors 10_1 to 10_4, second conductors 20_1 to 20_4, and an element body 30. Hereinafter, unless otherwise distinguished, the first conductors 10_1 to 10_4 are collectively referred to as a “first conductor 10”. In addition, unless otherwise distinguished, the second conductors 20_1 to 20_4 are collectively referred to as a “second conductor 20”.

The element body 30 is formed of a composite material containing a magnetic material and a resin, and partially covers each of the first conductor 10 and the second conductor 20. The element body 30 includes an outer core 40 and an inner core 50. The outer core 40 contains a magnetic material and a resin. The outer core 40 is molded by various molding techniques such as resin molding, transfer molding, injection molding, and dry molding. The inner core 50 contains a magnetic material while containing no resin. However, in another embodiment, the inner core 50 may contain a resin in addition to a magnetic material. The inner core 50 is formed by various forming techniques such as sintering.

The magnetic material constituting the element body 30 is not particularly limited, but is, for example, ferrite or a metallic magnetic material. Examples of the ferrite include Ni-Zn ferrite, Mn-Zn ferrite particles, and the like. Examples of the metallic magnetic material include Fe-Ni alloy powder, Fe-Si alloy powder, Fe-Si-Cr alloy powder, Fe-Co alloy powder, Fe-Si-Al alloy powder, amorphous iron, and the like. The resin constituting the element body 30 is not particularly limited, but is, for example, an epoxy resin, a phenolic resin, a polyester resin, a polyurethane resin, or a polyimide resin.

The outer core 40 has a mounting surface 41. The mounting surface 41 is a surface facing a mounting substrate (not illustrated) for mounting the coil device 1. Here, in FIGS. 1A and the like, the Z-axis is an axis perpendicular to the mounting surface 41. The X-axis is, for example, an axis along the winding axis direction of a first winding portion 11 of the first conductor 10. The Y-axis is, for example, an axis along the extending direction of a first terminal portion 13a or 13b of the first conductor 10. The X-axis, the Y-axis, and the Z-axis are perpendicular to each other. Hereinafter, the positive direction of the Z-axis is defined as upward, and the negative direction of the Z-axis is defined as downward.

In the present disclosure, the term “perpendicular” does not refer only to a strictly perpendicular orientation, but also includes an orientation having a deviation of ±Δθ° or less (where Δθ is, for example, 3, although not particularly limited) relative to the strict perpendicular orientation. In addition, the term "parallel" does not only refer to a strictly parallel orientation, but also includes an orientation having a deviation of ±Δθ° or less (where Δθ is, for example, 3, although not particularly limited) relative to the strictly parallel orientation.

The length of the element body 30 in an X-axis direction is not particularly limited, but is, for example, 3.0 mm to 40.0 mm. The length of the element body 30 in a Y-axis direction is not particularly limited, but is, for example, 3.0 mm to 20.0 mm. The length of the element body 30 in a Z-axis direction is not particularly limited, but is, for example, 2.0 mm to 10.0 mm.

The external shape of the element body 30 is a hexahedron (rectangular parallelepiped), but may be another polyhedron such as an octahedron, or a columnar shape such as a circular columnar shape. In the present disclosure, examples of the columnar shape also include a three-dimensional shape in which surfaces facing each other in the Z-axis direction are not congruent, such as a truncated cone shape.

The inner core 50 is disposed inside a second winding portion 21 of each of the second conductors 20_1 to 20_4, and penetrates through the interior of the second winding portion 21 of each of the second conductors 20_1 to 20_4. The external shape of the inner core 50 is a substantially hexahedron, but may be another polyhedron such as an octahedron. In the example illustrated in FIG. 1A, in a cross section perpendicular to the winding axis direction of the second winding portion 21, the shape of an outer peripheral surface of the inner core 50 is substantially rectangular.

The material constituting the inner core 50 may be the same as the material constituting the outer core 40 or may be different from the material constituting the outer core 40. A part of the outer peripheral surface of the inner core 50 may be bonded to an inner peripheral surface of the second conductor 20.

The first conductor 10 is formed of a plate-shaped conductor, and includes the first winding portion 11 and a pair of the first terminal portions 13a and 13b continuous with both ends of the first winding portion 11. Hereinafter, unless otherwise distinguished, the first terminal portions 13a and 13b are collectively referred to as a “first terminal portion 13”.

The first conductor 10 is formed of, for example, a machined metal plate. The material constituting the first conductor 10 is not particularly limited, but is, for example, a metal such as copper, a copper alloy, silver, or nickel. The thickness of the first conductor 10 (the length between an inner peripheral surface and an outer peripheral surface of the first conductor 10) is not particularly limited, but is, for example, 0.1 mm to 2.5 mm. The width (here, the width in the X-axis direction) of the first conductor 10 is not particularly limited, but is, for example, 0.2 mm to 10 mm. When the coil device 1 is used as a coupled inductor, the first conductor 10 functions as, for example, a primary conductor.

The first winding portion 11 is embedded in the outer core 40. The first winding portion 11 is curved in a C-shape or a U-shape, and the number of turns of the first winding portion 11 is less than one turn. The winding axis direction of the first winding portion 11 corresponds to the X-axis direction. The maximum length of the first winding portion 11 in the Y-axis direction is larger than the height of the first winding portion 11, but may be equal to or less than the height of the first winding portion 11.

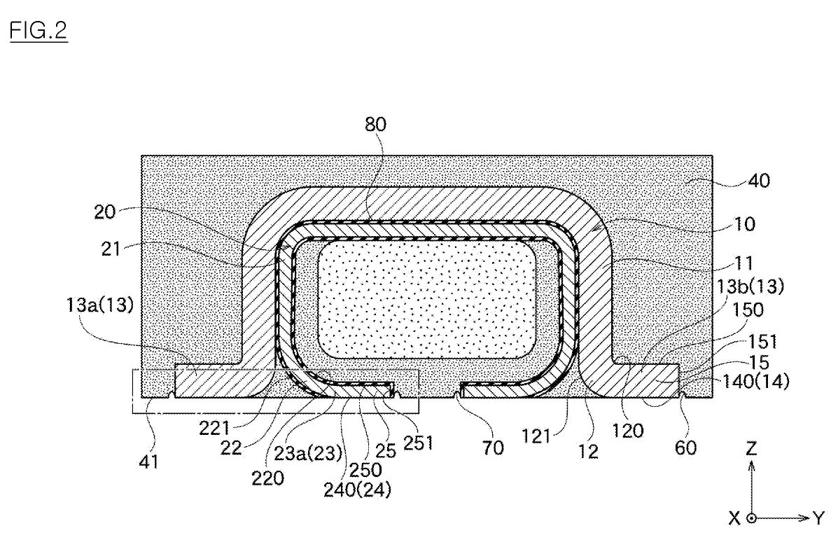

As illustrated in FIG. 2, the first winding portion 11 includes a first curved portion 12 curved so as to be continuous with the first terminal portion 13. Although not particularly limited, the radius of curvature of an inner peripheral surface 120 of the first curved portion 12 is smaller than the radius of curvature of an outer peripheral surface 121 of the first curved portion 12.

The first terminal portion 13 functions as a terminal electrode for electrically connecting the first conductor 10 to the land pattern of the mounting substrate (not illustrated). The first terminal portion 13 may be connected to the land pattern of the mounting substrate by, for example, solder or a conductive adhesive. The first terminal portions 13a and 13b are provided at both end portions of the first winding portion 11, and extend along the mounting surface 41 in directions away from each other.

The first terminal portion 13 includes an exposed portion 14 and an embedded portion 15. The exposed portion 14 is exposed from the mounting surface 41, and the embedded portion 15 is embedded in the outer core 40. The exposed portion 14 has an exposed surface 140 exposed from the mounting surface 41. The exposed surface 140 extend along the mounting surface 41. The exposed portion 14 may protrude downward from the mounting surface 41. The embedded portion 15 has an embedded surface 150 and a distal end surface 151 that are embedded in the outer core 40. The embedded surface 150 faces the exposed surface 140. The distal end surface 151 is located at a distal end of the first terminal portion 13, and connects the exposed surface 140 and the embedded surface 150.

As illustrated in FIG. 1A, the second conductor 20 is provided inside the first conductor 10. The second conductor 20 is formed of a plate-shaped conductor, and includes the second winding portion 21 and a pair of second terminal portions 23a and 23b continuous with both ends of the second winding portion 21. Hereinafter, unless otherwise distinguished, the second terminal portions 23a and 23b are collectively referred to as a “second terminal portion 23”.

The second conductor 20 is formed of, for example, a machined metal plate. The material constituting the second conductor 20 is the same as the material constituting the first conductor 10, but may be different therefrom. The thickness of the second conductor 20 (the length between the inner peripheral surface and an outer peripheral surface of the second conductor 20) is not particularly limited, but is, for example, 0.1 mm to 1 mm. The width (here, the width in the X-axis direction) of the second conductor 20 is not particularly limited, but is, for example, 0.2 mm to 10 mm. When the coil device 1 is used as a coupled inductor, the second conductor 20 functions as, for example, a secondary conductor.

The second winding portion 21 is embedded in the outer core 40. The second winding portion 21 is curved in a C-shape or a U-shape, and the number of turns of the second winding portion 21 is less than one turn. The winding axis direction of the second winding portion 21 corresponds to the X-axis direction. The maximum length of the second winding portion 21 in the Y-axis direction is larger than the height of the second winding portion 21, but may be equal to or less than the height of the second winding portion 21.

As illustrated in FIG. 2, the second winding portion 21 includes a second curved portion 22 curved so as to be continuous with the second terminal portion 23. Although not particularly limited, the radius of curvature of an inner peripheral surface 220 of the second curved portion 22 is smaller than the radius of curvature of an outer peripheral surface 221 of the second curved portion 22.

The second terminal portion 23 functions as a terminal electrode for electrically connecting the second conductor 20 to the land pattern of the mounting substrate (not illustrated). The second terminal portion 23 may be connected to the land pattern of the mounting substrate by, for example, solder or a conductive adhesive. The second terminal portions 23a and 23b are provided at both end portions of the second winding portion 21, and extend along the mounting surface 41 in directions toward each other.

As illustrated in FIG. 2, the second terminal portion 23 includes an exposed portion 24 and an embedded portion 25. The exposed portion 24 is exposed from the mounting surface 41, and the embedded portion 25 is embedded in the outer core 40. The exposed portion 24 has an exposed surface 240 exposed from the mounting surface 41. The exposed surface 240 extend along the mounting surface 41. The exposed portion 24 may protrude downward from the mounting surface 41. The embedded portion 25 has an embedded surface 250 and a distal end surface 251 that are embedded in the outer core 40. The embedded surface 250 faces the exposed surface 240. The distal end surface 251 is located at a distal end of the second terminal portion 23, and connects the exposed surface 240 and the embedded surface 250.

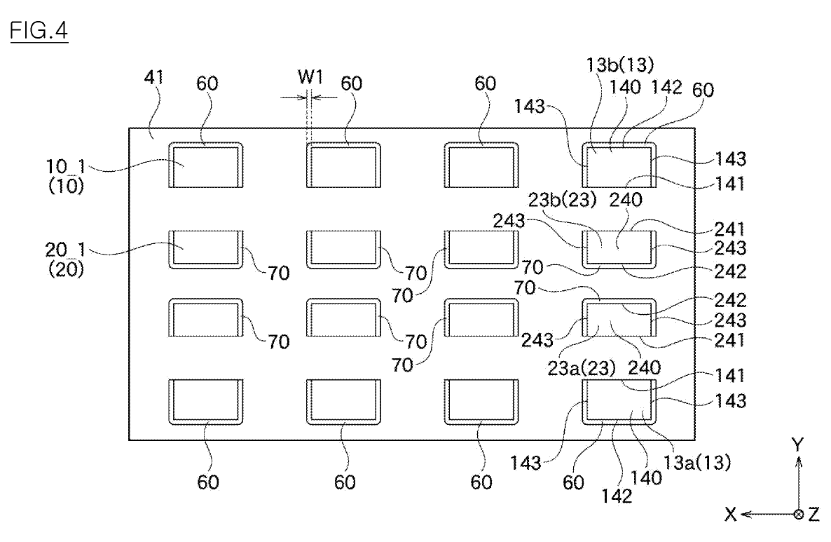

As illustrated in FIG. 4, the outer periphery of the exposed surface 140 includes a first portion 141, a second portion 142, and a pair of third portions 143. The first portion 141 is located on a proximal end side of the first terminal portion 13. Here, the proximal end side of the first terminal portion 13 is the side of the first terminal portion 13 that is close to an end portion of the first winding portion 11. The second portion 142 faces the first portion 141, and is located on a distal end side of the first terminal portion 13. The pair of third portions 143 face each other, and connect the first portion 141 and the second portion 142. Each of the first portion 141, the second portion 142, and the third portions 143 extends linearly, but may be curved or bent.

The outer periphery of the exposed surface 240 includes a first portion 241, a second portion 242, and a pair of third portions 243. The first portion 241 is located on a proximal end side of the second terminal portion 23. Here, the proximal end side of the second terminal portion 23 is the side of the second terminal portion 23 that is close to an end portion of the second winding portion 21. The second portion 242 faces the first portion 241, and is located on a distal end side of the second terminal portion 23. The pair of third portions 243 face each other, and connect the first portion 241 and the second portion 242. Each of the first portion 241, the second portion 242, and the third portions 243 extends linearly, but may be curved or bent.

As illustrated in FIG. 2, at least one of the first conductor 10 and the second conductor 20 has an insulating layer 80 covering the surface thereof. In the present embodiment, the second conductor 20 has the insulating layer 80 covering the surface thereof. The first conductor 10 does not have the insulating layer 80; however, the first conductor 10 may have the insulating layer 80 covering the surface thereof. The material constituting the insulating layer 80 is not particularly limited, but is, for example, polyester, polyesterimide, polyamide, polyamideimide, polyurethane, epoxy, or epoxy-modified acrylic resin.

The insulating layer 80 covers at least a part (in the present embodiment, the entirety) of the second winding portion 21. The first conductor 10 and the second conductor 20 can be insulated from each other by the insulating layer 80. In addition, the insulating layer 80 partially covers the second terminal portion 23. The insulating layer 80 is removed from the exposed surface 240 of the second terminal portion 23 that contributes to connection with the land pattern of the mounting substrate.

As illustrated in FIG. 4, grooves 60 and 70 are provided in the mounting surface 41. When viewed in a direction perpendicular to the mounting surface 41, the groove 60 is provided around the exposed portion 14 (exposed surface 140). Here, the region around the exposed portion 14 includes positions spaced apart from the outer periphery of the exposed portion 14 by a distance Δ in the X-axis direction or the Y-axis direction. The distance Δ is, for example, 1/8 to 1/3 of the width of the first terminal portion 13 in the X-axis direction. When viewed in a direction perpendicular to the mounting surface 41, the groove 60 is provided along at least a part of the outer periphery of the exposed portion 14 (exposed surface 140). In the present embodiment, the groove 60 is provided along the second portion 142 and the pair of third portions 143, but is not provided along the first portion 141.

The groove 60 extends continuously along the second portion 142, but may extend intermittently along the second portion 142. In addition, the groove 60 is provided along the entire length of the second portion 142, but may be provided along a part of the second portion 142.

The groove 60 extends continuously along each of the pair of third portions 143, but may extend intermittently along each of the pair of third portions 143. In addition, the groove 60 is provided along the entire length of each of the pair of third portions 143, but may be provided along a part of each of the pair of third portions 143.

When viewed in a direction perpendicular to the mounting surface 41, the groove 60 is provided around the exposed surface 140 of each of the first terminal portions 13a and 13b. However, when viewed in a direction perpendicular to the mounting surface 41, the groove 60 may be provided around the exposed surface 140 of one of the first terminal portions 13a and 13b.

The average width or the maximum width W1 of the groove 60 in a direction perpendicular to the extending direction of the groove 60 is not particularly limited, but is, for example, 100 μm ≤ W1 ≤ 300 μm. The average width or the maximum width W1 of the groove 60 is smaller than the width (here, the width in the X-axis direction) of the first terminal portion 13. In FIG. 4, the groove 60 is illustrated such that the width of the groove 60 is constant. However, the width of the groove 60 may not be constant, and the groove 60 may include a relatively narrow portion and a relatively wide portion.

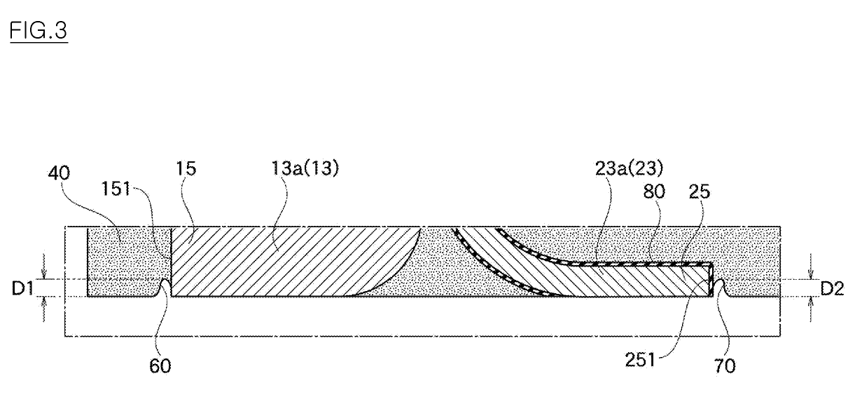

As illustrated in FIG. 3, the depth D1 of the groove 60 is not particularly limited, but is, for example, 10 μm ≤ D1 ≤ 100 μm. The depth D1 of the groove 60 is smaller than the thickness of the first terminal portion 13. In the example illustrated in FIG. 3, in at least a part of the groove 60, the depth D1 of the groove 60 gradually increases toward the first terminal portion 13.

In addition, in the example illustrated in FIG. 3, the distal end surface 151 is exposed from the outer core 40 on the inner wall of the groove 60. However, the distal end surface 151 may be covered by the outer core 40 rather than being exposed from the inner wall of the groove 60.

As illustrated in FIG. 4, when viewed in a direction perpendicular to the mounting surface 41, the groove 70 is provided around the exposed portion 24 (exposed surface 240). In addition, when viewed in a direction perpendicular to the mounting surface 41, the groove 70 is provided along at least a part of the outer periphery of the exposed portion 24 (exposed surface 240). In the present embodiment, the groove 70 is provided along the second portion 242 and the pair of third portions 243, but is not provided along the first portion 241.

The groove 70 extends continuously along the second portion 242, but may extend intermittently along the second portion 242. In addition, the groove 70 is provided along the entire length of the second portion 242, but may be provided along a part of the second portion 242.

The groove 70 extends continuously along each of the pair of third portions 243, but may extend intermittently along each of the pair of third portions 243. In addition, the groove 70 is provided along the entire length of each of the pair of third portions 243, but may be provided along a part of each of the pair of third portions 243.

When viewed in a direction perpendicular to the mounting surface 41, the groove 70 is provided around the exposed surface 240 of each of the second terminal portions 23a and 23b. However, when viewed in a direction perpendicular to the mounting surface 41, the groove 70 may be provided around the exposed surface 240 of one of the second terminal portions 23a and 23b.

When viewed in a direction perpendicular to the mounting surface 41, at least a part of the groove 70 is located between the second terminal portion 23a and the second terminal portion 23b. In the present embodiment, when viewed in a direction perpendicular to the mounting surface 41, at least a part of the groove 70 is located between a distal end portion of the second terminal portion 23a (the second portion 242 of the exposed surface 240) and a distal end portion of the second terminal portion 23b (the second portion 242 of the exposed surface 240).

The average width or the maximum width W2 of the groove 70 in a direction perpendicular to the extending direction of the groove 70 is not particularly limited, but is, for example, 100 μm ≤ W2 ≤ 300 μm. The average width or the maximum width W2 of the groove 70 is smaller than the width (here, the width in the X-axis direction) of the second terminal portion 23. In FIG. 4, the groove 70 is illustrated such that the width of the groove 70 is constant. However, the width of the groove 70 may not be constant, and the groove 70 may include a relatively narrow portion and a relatively wide portion.

As illustrated in FIG. 3, the depth D2 of the groove 70 is not particularly limited, but is, for example, 10 μm D2 100 μm. The depth D2 of the groove 70 is smaller than the thickness of the second terminal portion 23. In the example illustrated in FIG. 3, in at least a part of the groove 70, the depth D2 of the groove 70 gradually increases toward the second terminal portion 23.

In addition, in the example illustrated in FIG. 3, a part of the distal end surface 251 (note that the distal end surface 251 is covered by the insulating layer 80) is exposed from the outer core 40 on the inner wall of the groove 70. However, the second terminal portion 23 may be covered by the outer core 40 rather than being exposed from the inner wall of the groove 70.

Next, a method for manufacturing the coil device 1 will be described with reference to FIGS. 1A and 1B. First, the first conductor 10, the second conductor 20, and the inner core 50 molded in advance, which are illustrated in FIG. 1A are prepared. Next, the second conductor 20 is superimposed on the first conductor 10 such that the second conductor 20 is disposed inside the first conductor 10. If necessary, at least a part of an outer peripheral surface of the second winding portion 21 is bonded to an inner peripheral surface of the first winding portion 11. In addition, the inner core 50 is inserted into the interior of each of the second conductors 20_1 to 20_4 so as to penetrate the interior of each of the second conductors 20_1 to 20_4. If necessary, at least a part of an outer peripheral surface of the second winding portion 21 is bonded to an inner peripheral surface of the inner core 50.

Next, pairs of the first conductors 10 and the second conductors 20 are disposed in a cavity of a press mold in a state where the inner core 50 is mounted. Next, the cavity is filled with a composite material containing a magnetic material and a resin such that the exposed portions 14 and 24 (exposed surfaces 140 and 240) are exposed from the mounting surface 41, and the embedded portions 15 and 25 are embedded in the outer core 40. Then, the outer core 40 is molded by compressing and curing the composite material. Accordingly, the element body 30 containing the outer core 40 and the inner core 50 is formed.

Examples of a method for forming the grooves 60 and 70 illustrated in FIG. 1B in the mounting surface 41 include the following method. For example, projections corresponding to the grooves 60 and 70 are provided on the press mold. Accordingly, when the outer core 40 is molded, the grooves 60 and 70 can be formed in the mounting surface 41. Alternatively, after the outer core 40 is molded, the grooves 60 and 70 may be formed in the mounting surface 41 using a jig. In the manner described above, the coil device 1 illustrated in FIG. 1A can be manufactured.

As illustrated in FIG. 4, in the coil device 1 of the present disclosure, the groove 60 or 70 is provided around the outer periphery of the exposed portion 14 or 24. Therefore, the creepage distance between adjacent terminal portions is extended depending on the depth or width of the groove 60 or 70, so that the insulation (withstand voltage) between the adjacent terminal portions can be enhanced. Here, the creepage distance between the adjacent terminal portions is, for example, a creepage distance between the first terminal portion 13 and the second terminal portion 23, a creepage distance between the first terminal portion 13a and the first terminal portion 13b, a creepage distance between the second terminal portion 23a and the second terminal portion 23b, or a creepage distance between the first terminal portion 13 or the second terminal portion 23 of one coil device 1 and the first terminal portion 13 or the second terminal portion 23 of the other coil device 1 that are provided adjacent to each other.

In addition, in the coil device 1 of the present disclosure, the groove 60 or 70 is provided along at least a part of the outer periphery of the exposed portion 14 or 24. Therefore, the groove 60 or 70 is formed along the outer periphery of the exposed portion 14 or 24 over a predetermined range. Accordingly, the creepage distance between adjacent terminal portions can be effectively extended depending on the depth or width of the groove 60 or 70.

In addition, in the coil device 1 of the present disclosure, when viewed in a direction perpendicular to the mounting surface 41, at least a part of the groove 70 is located between the second terminal portion 23a and the second terminal portion 23b. Therefore, for example, the creepage distance between input and output terminal portions (between the second terminal portion 23a and the second terminal portion 23b) of the second conductor 20 is extended depending on the depth or width of the groove 70, so that the insulation between the input and output terminal portions can be enhanced.

In addition, in the coil device 1 of the present disclosure, when viewed in a direction perpendicular to the mounting surface 41, at least a part of the groove 70 is located between the respective distal end portions of the second terminal portion 23a and the second terminal portion 23b. Therefore, in a conductor such as the second conductor 20 in which the second terminal portion 23a and the second terminal portion 23b extend in directions toward each other, for example, the creepage distance between input and output terminal portions of the conductor is extended depending on the depth or width of the groove 70, so that the insulation between the input and output terminal portions can be enhanced.

In addition, in the coil device 1 of the present disclosure, the groove 60 (70) is provided along the second portion 142 (242) and the third portions 143 (243). Therefore, the creepage distance between adjacent terminal portions is extended depending on the depth or width of the groove 60 (70) provided along the second portion 142 (242) and the third portions 143 (243), so that the insulation between the adjacent terminal portions can be effectively enhanced.

In addition, in the coil device 1 of the present disclosure, the groove 60 or 70 is not provided along the first portion 141 or 241. Therefore, the volume of the element body 30 is ensured along the first portion 141 or 241, which can contribute to an improvement in the inductance characteristics of the coil device 1, in addition to the above-described effect (an improvement in insulation between input and output terminal portions or between adjacent terminal portions).

The present disclosure is not limited to the embodiment described above, and can be modified in various ways within the scope of the present disclosure.

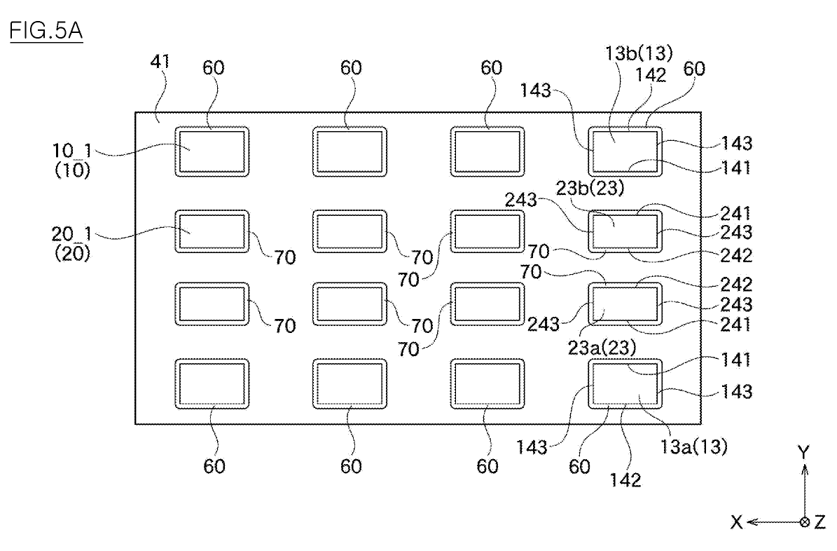

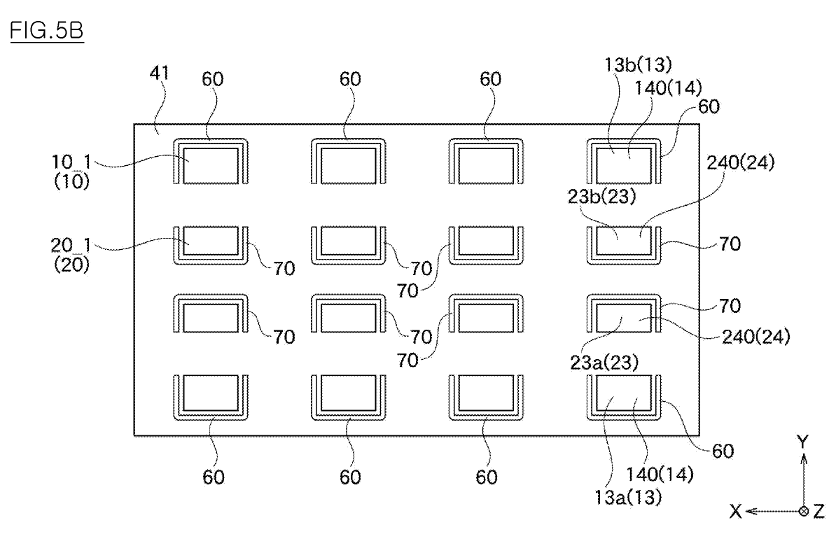

As illustrated in FIG. 5A, the groove 60 may be provided along the first portion 141 in addition to the second portion 142 and the third portions 143. The groove 60 extends continuously along the first portion 141, but may extend intermittently along the first portion 141. In addition, the groove 60 is provided along the entire length of the first portion 141, but may be provided along a part of the first portion 141.

In addition, the groove 70 may be provided along the first portion 241 in addition to the second portion 242 and the third portions 243. The groove 70 extends continuously along the first portion 241, but may extend intermittently along the first portion 241. In addition, the groove 70 is provided along the entire length of the first portion 241, but may be provided along a part of the first portion 241.

In the coil device 1 illustrated in FIG. 5A, the groove 60 (70) is provided along the first portion 141 (241) in addition to the second portion 142 (242) and the third portions 143 (243). Therefore, the creepage distance between adjacent terminal portions is extended depending on the depth or width of the groove 60 (70) provided along the first portion 141 (241) to the third portions 143 (243), so that the insulation between the adjacent terminal portions can be effectively enhanced.

In addition, when viewed in a direction perpendicular to the mounting surface 41, at least a part of the groove 60 is located between the first terminal portion 13a and the first terminal portion 13b. Therefore, for example, the creepage distance between input and output terminal portions of the first conductor 10 is extended depending on the depth or width of the groove 60, so that the insulation between the input and output terminal portions can be enhanced.

As illustrated in FIG. 5B, the groove 60 does not necessarily need to be in contact with the outer periphery of the exposed portion 14 (exposed surface 140), and may be provided at a position spaced apart from the outer periphery of the exposed portion 14. In addition, the groove 70 does not necessarily need to be in contact with the outer periphery of the exposed portion 24 (exposed surface 240), and may be provided at a position spaced apart from the outer periphery of the exposed portion 24.

As illustrated in FIG. 1B, in the above-described embodiment, the grooves 60 and 70 are provided in the mounting surface 41. However, one of the grooves 60 and 70 may be provided in the mounting surface 41.

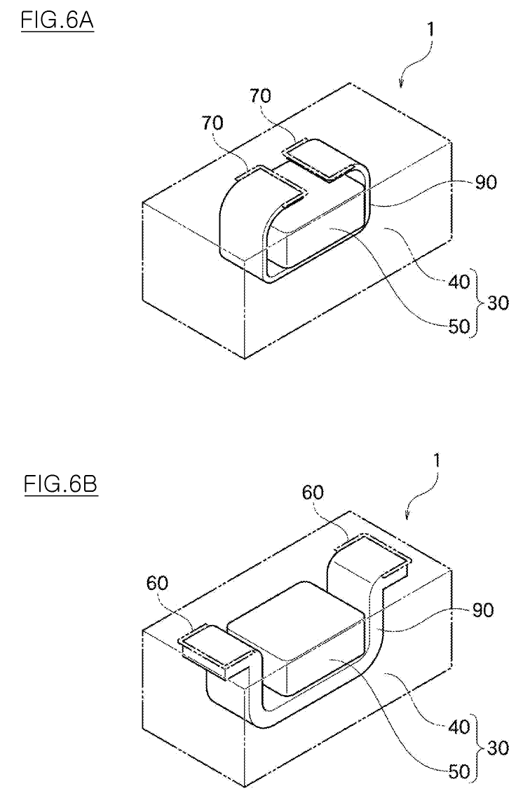

As illustrated in FIG. 1A, in the above-described embodiment, the coil device 1 includes a pair of conductors having the first conductor 10 and the second conductor 20. However, the conductors included in the coil device 1 may not form pairs. In addition, the above-described embodiment, the number of pairs of the first conductors 10 and the second conductors 20 is four. However, the number of pairs of the first conductors 10 and the second conductors 20 may be one to three, or five or more. For example, the coil device 1 illustrated in FIG. 6A is provided with one conductor 90 having a shape similar to that of the second conductor 20 illustrated in FIG. 1B. In addition, the coil device 1 illustrated in FIG. 6B is provided with one conductor 90 having a shape similar to that of the first conductor 10 illustrated in FIG. 1B. In the coil device 1 illustrated in FIGS. 6A and 6B, similarly to the coil device 1 illustrated in FIG. 5A, the groove 60 or 70 may be provided along the first portion 141 (241) in addition to the second portion 142 (242) and the third portions 143 (243).

As illustrated in FIG. 1A, in the above-described embodiment, the element body 30 has two cores, namely, the outer core 40 and the inner core 50. However, the element body 30 may have one core corresponding to the outer core 40.

As illustrated in FIG. 1A, in the above-described embodiment, one inner core 50 is disposed inside the second winding portion 21 of each of the second conductors 20_1 to 20_4 so as to penetrate through the interior of the second winding portion 21 of each of the second conductors 20_1 to 20_4. However, four inner cores 50 may be disposed inside the respective second winding portions 21 of the second conductors 20_1 to 20_4.

The present specification discloses the following.

### Supplementary Note 1

A coil device includes an element body containing a magnetic material and a resin and having a mounting surface; and a conductor including a winding portion embedded in the element body, and a terminal portion provided at an end portion of the winding portion and extending along the mounting surface. The terminal portion includes an exposed portion exposed from the mounting surface. A groove is provided in the mounting surface. When viewed in a direction perpendicular to the mounting surface, the groove is provided around the exposed portion.

### Supplementary Note 2

In the coil device according to Supplementary Note 1, when viewed in a direction perpendicular to the mounting surface, the groove is provided along at least a part of an outer periphery of the exposed portion.

### Supplementary Note 3

In the coil device according to Supplementary Note 1 or 2, the terminal portion comprises a pair of terminal portions provided at both end portions of the winding portion. When viewed in a direction perpendicular to the mounting surface, at least a part of the groove is located between the pair of terminal portions.

### Supplementary Note 4

In the coil device according to Supplementary Note 3, the pair of terminal portions extend from both end portions of the winding portion in directions toward each other. When viewed in a direction perpendicular to the mounting surface, at least a part of the groove is located between respective distal end portions of the pair of terminal portions.

### Supplementary Note 5

In the coil device according to any one of Supplementary Notes 1 to 4, an outer periphery of the exposed portion includes a first portion located on a proximal end side of the terminal portion, a second portion facing the first portion and located on a distal end side of the terminal portion, and a third portion connecting the first portion and the second portion. The groove is provided along the second portion and the third portion.

### Supplementary Note 6

In the coil device according to Supplementary Note 5, the groove is not provided along the first portion.

### Supplementary Note 7

In the coil device according to Supplementary Note 5, the groove is provided along the first portion in addition to the second portion and the third portion.

### Supplementary Note 8

In the coil device according to any one of Supplementary Notes 1 to 7, the conductor comprises a first conductor and a second conductor provided inside the first conductor. The first conductor includes a first winding portion and a first terminal portion provided at an end portion of the first winding portion and extending along the mounting surface. The second conductor includes a second winding portion and a second terminal portion provided at an end portion of the second winding portion and extending along the mounting surface. The first terminal portion includes a first exposed portion exposed from the mounting surface. The second terminal portion includes a second exposed portion exposed from the mounting surface. When viewed in a direction perpendicular to the mounting surface, the groove is provided around the first exposed portion and is also provided around the second exposed portion.

### EXPLANATIONS OF LETTERS OR NUMERALS

1 COIL DEVICE

10_1 to 10_4 FIRST CONDUCTOR

11 FIRST WINDING PORTION

12 FIRST CURVED PORTION

120 INNER PERIPHERAL SURFACE

121 OUTER PERIPHERAL SURFACE

13a, 13b FIRST TERMINAL PORTION

14 EXPOSED PORTION

140 EXPOSED SURFACE

141 FIRST PORTION

142 SECOND PORTION

143 THIRD PORTION

15 EMBEDDED PORTION

150 EMBEDDED SURFACE

151 DISTAL END SURFACE

20_1 to 20_4 SECOND CONDUCTOR

21 SECOND WINDING PORTION

22 SECOND CURVED PORTION

220 INNER PERIPHERAL SURFACE

221 OUTER PERIPHERAL SURFACE

23a, 23b SECOND TERMINAL PORTION

24 EXPOSED PORTION

240 EXPOSED SURFACE

241 FIRST PORTION

242 SECOND PORTION

243 THIRD PORTION

25 EMBEDDED PORTION

250 EMBEDDED SURFACE

251 DISTAL END SURFACE

30 ELEMENT BODY

40 OUTER CORE

41 MOUNTING SURFACE

50 INNER CORE

60, 70 GROOVE

80 INSULATING LAYER

90 CONDUCTOR

What is claimed is:

1. A coil device comprising:
an element body containing a magnetic material and a resin and having a mounting surface; and
a conductor including a winding portion embedded in the element body, and a terminal portion provided at an end portion of the winding portion and extending along the mounting surface,
wherein the terminal portion includes an exposed portion exposed from the mounting surface,
a groove is provided in the mounting surface, and
when viewed in a direction perpendicular to the mounting surface, the groove is provided around the exposed portion.

2. The coil device according to claim 1,
wherein, when viewed in a direction perpendicular to the mounting surface, the groove is provided along at least a part of an outer periphery of the exposed portion.

3. The coil device according to claim 1,
wherein the terminal portion comprises a pair of terminal portions provided at both end portions of the winding portion, and
when viewed in a direction perpendicular to the mounting surface, at least a part of the groove is located between the pair of terminal portions.

4. The coil device according to claim 3,
wherein the pair of terminal portions extend from both end portions of the winding portion in directions toward each other, and
when viewed in a direction perpendicular to the mounting surface, at least a part of the groove is located between respective distal end portions of the pair of terminal portions.

5. The coil device according to claim 1,
wherein an outer periphery of the exposed portion includes a first portion located on a proximal end side of the terminal portion, a second portion facing the first portion and located on a distal end side of the terminal portion, and a third portion connecting the first portion and the second portion, and
the groove is provided along the second portion and the third portion.

6. The coil device according to claim 5,
wherein the groove is not provided along the first portion.

7. The coil device according to claim 5,
wherein the groove is provided along the first portion in addition to the second portion and the third portion.

8. The coil device according to claim 1,
wherein the conductor comprises a first conductor and a second conductor provided inside the first conductor.
the first conductor includes a first winding portion and a first terminal portion provided at an end portion of the first winding portion and extending along the mounting surface,
the second conductor includes a second winding portion and a second terminal portion provided at an end portion of the second winding portion and extending along the mounting surface,
the first terminal portion includes a first exposed portion exposed from the mounting surface,
the second terminal portion includes a second exposed portion exposed from the mounting surface, and
when viewed in a direction perpendicular to the mounting surface, the groove is provided around the first exposed portion and is also provided around the second exposed portion.
